(19) United States
(12) Patent Application Publication
(10) Pub. No.: US 2006/0055150 A1
(43) Pub. Date: Mar. 16, 2006

(54) Vehicle mount assembly for a utilitarian accessory

(75) Inventor: Marc D Curtis, Spencer, MA (US)

Correspondence Address: NIELDS & LEMACK, 176 EAST MAIN STREET, SUITE 7, WESTBORO, MA, 01581, US

(73) Assignee: LTT BIIO-PHARA CO., LTD, mIATO-KU (JP)

(21) Appl. No.: 10/523,630

(22) PCT Filed: Sep. 10, 2004
(86) PCT No.: PCT/US04/29877

§ 371 Date: Feb. 4, 2005

Related U.S. Application Data
(60) Provisional application No. 60/506,924, filed on Sep. 29, 2003.

(51) Int. Cl. B60D 1/36

(52) U.S. Cl. 280/477

(57) ABSTRACT

Hitch mount assembly for snow blades or other accessories or implements for pick-up trucks or off-road vehicles such as utility task vehicles. The assembly includes a receiver for mounting to the vehicle chassis and an implement assembly readily removably coupled to the receiver. The configuration of the receiver and implement assembly allows for selfalignment during the mounting operation. One or more over center latches draw the receiver and mounting assembly together.

### BACKGROUND OF THE INVENTION

Conventional snow blade mounts for four wheel drive vehicles such as pick-up trucks can weigh several hundred pounds, and generally include a chassis frame that can be permanently fixed to the vehicle chassis, usually behind the vehicle front bumper. A lift frame is then removably coupled to the chassis frame, and the snow blade is then coupled to the front end of the assembly via an A-frame and trip frame assembly. The A-frame with the snow blade attached is typically removable from the vehicle. Conventionally, the lift frame has been permanently mounted to the chassis frame (and therefore not readily removable from the vehicle), and the hydraulic pump used to operate the snow blade was located under the vehicle hood, and were driven using a belt drive driven by the vehicle engine. However, safety considerations now often dictate that the lift frame be removed when the plow is not in use. In addition, crash zones and barrier testing are altered by locating the electric/hydraulic pump under the vehicle hood in juxtaposition with the vehicle engine. Moreover, such a location is also no longer feasible since there is little room there to accommodate the pump, and since most vehicles today use a single serpentine belt, again eliminating the feasibility of driving the hydraulics with a belt driven by the vehicle engine. Accordingly, most snow blade mounts today locate the blade actuator drive assembly in front of the vehicle grill, slightly higher than the vehicle front bumper. This arrangement hinders air flow to the vehicle engine, often resulting in engine overheats.

One drawback of conventional snow blade mounts is the difficulty in readily removing the lift frame assemblies from the vehicle chassis, especially in view of their weight. Conventional mounting systems utilize a pin arrangement, whereby the vehicle and mount assembly must be properly aligned prior to coupling the mount to the chassis with a pair of pins. This mounting and dismounting is difficult and tedious.

Utility task vehicles or UTV's are versatile all-season three or four-wheeled motorized vehicles designed for off-road use. They are commonly used in the construction and utility industries, on golf courses and by towns and municipalities. Typically UTV's are generally designed to carry one or two passengers, and to carry or two large payloads. They generally are equipped with engines having maximum horsepower of about 35, particular 32 or less. Various utilitarian accessories or implements, such as snowplow blades, can be attached to the UTV. Although the relatively lightweight of the UTV allows for the use of small engines, the small engines limit the power capabilities; UTV's generally have a battery and battery recharging system having low amperage storage and low amperage recharging capability relative to a typically automobile.

Such assemblies, however, are too large and too heavy for practical use with the relatively small UTV. One drawback of conventional snow blade mounts is the difficulty in readily removing the assemblies from the vehicle chassis, especially in view of their weight. The presence of an implement or accessory on a UTV can render the UTV useless. Accordingly, it is highly desirable that the blade be removed after use. However, since the mounting and dismounting operation can be cumbersome and time-consuming, the assemblies are often left on the UTV for the entire winter season.

It is therefore an object of the present invention to provide a mount and lift assembly for a vehicle that is easily attachable and removable from the vehicle.

It is a further object of the present invention to provide a snow blade and lift assembly for a vehicle that is attached and removed from the vehicle using a self-aligning hitch mount devoid of conventional mounting pins.

It is therefore an object of the present invention to provide a utilitarian accessory mounting assembly for a UTV that is conveniently and easily attachable and removable from the vehicle.

It is a further object of the present invention to provide a snow blade assembly for an UTV that is mounted and dismounted from the vehicle using a self-aligning hitch mount devoid of mounting pins.

### SUMMARY OF THE INVENTION

The problems of the prior art have been overcome by the present invention, which provides a hitch mount assembly for snow blades or other accessories or implements for vehicles such as pick-up trucks and off-road vehicles such as utility task vehicles. The present invention includes an implement assembly readily removably coupled to the vehicle, such as in conjunction with a receiver that is mounted to the vehicle chassis or frame or is integrated therewith. The configuration of the receiver and implement assembly allows for self-alignment during the mounting operation. One or more over center latches draw the receiver and hitch mounting assembly together and lock them in place.

### BRIEF DESCRIPTION OF THE DRAWINGS

FIG. 1 is a perspective view of an implement mounting receiver assembly in accordance with the present invention;

FIG. 2 is a perspective view of a portion of the receiver of FIG. 1 in accordance with the present invention;

FIG. 3 is a top perspective view of an implement mounting assembly in accordance with the present invention;

FIG. 4 is a perspective side view of an implement mounting assembly in accordance with the present invention;

FIG. 5 is a perspective side view the implement mounting assembly of FIG. 4, showing the over-center latch in accordance with the present invention;

FIG. 6 is a perspective view showing the over-center latch engaging the receiver in accordance with the present invention;

FIG. 6A is a perspective view showing the over-center latch engaged in the receiver in accordance with the present invention;

FIG. 7 is a side view of an over-center latch in accordance with one embodiment of the present invention;

FIG. 8 is a perspective view of another embodiment of an implement mounting assembly in accordance with the present invention;

FIG. 9 is a perspective view of an implement mounting receiver assembly for use in conjunction with the implement mounting assembly of FIG. 8;

FIG. 10 is a perspective view of yet another embodiment of an implement mounting assembly in accordance with the present invention; and

FIG. 11 is a perspective view of an implement mounting receiver assembly for use in conjunction with the implement mounting assembly of FIG. 10.

### DETAILED DESCRIPTION OF THE INVENTION

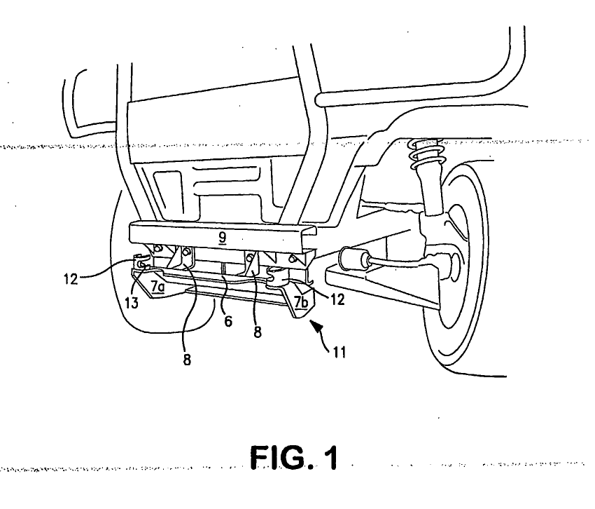

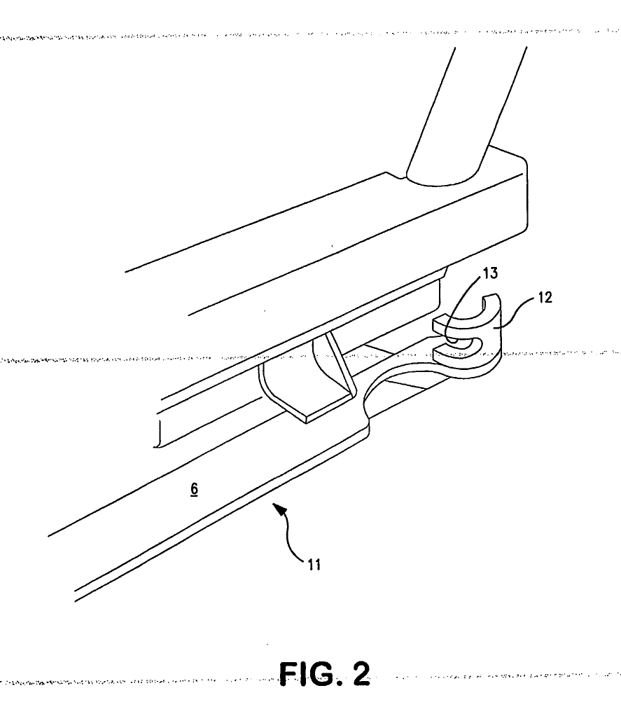

Turning first to FIG. 1, there is shown generally the receiver assembly in accordance with a preferred embodiment of the present invention. It is preferably made of durable, lightweight material, such as metal, steel, stainless steel, plastics or composites, for example, depending upon the relative strength required of each component. Vehicle mounted receiver 11 attaches to the vehicle chassis or frame, or is integrated therewith. Any Suitable means can be used to secure the receiver 11 to the vehicle, such as bolting or manufacturing integration (e.g., as a stamped component of the vehicle chassis or frame). For example, the receiver 11 can include a pair of brackets 8 with holes for coupling the receiver to the vehicle chassis, such as an existing frame 9 on a UTV. The design of the receiver 11 interface for attachment to the chassis will depend upon the identity (and thus design) of the particular chassis, and is well within the skill in the art. Because in the embodiment shown the receiver 11 is situated under the chassis and is not obtrusive, it optionally can be permanently affixed to the chassis, regardless of whether the snow plow blade or other accessories or working implements are attached or in use. Alternatively, the receiver can be located on the vehicle frame where it does not extend below the frame so as to provide adequate ground clearance. It is fixed and preferably has no moving parts; its main purpose being to provide a means of attachment of the follow-on components. It also can absorb and transfer any shock loads imposed on the snow blade (or other accessory) into the vehicle. It can be made of any rigid material suitable for the job, such as steel, metal, stainless steel, plastic or composites, for example.

As best seen in FIG. 1, the receiver 11 is preferably shaped to taper towards its rear, uniformly tapering inwardly from its open front end towards the rear of the vehicle. It has an optional top plate 6, with opposite vertically depending side guides 7a and 7b as shown. Alternatively, the dimensioned larger than the elongated member 14 so as not be be receivable by the slot.

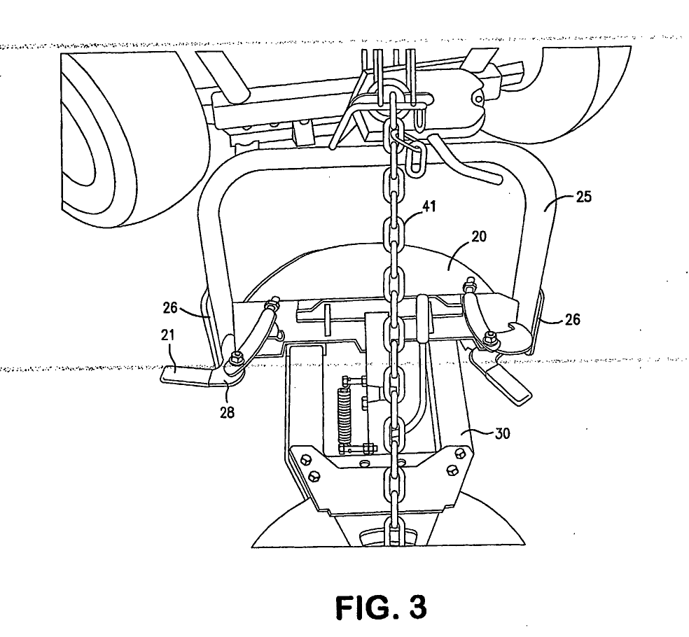

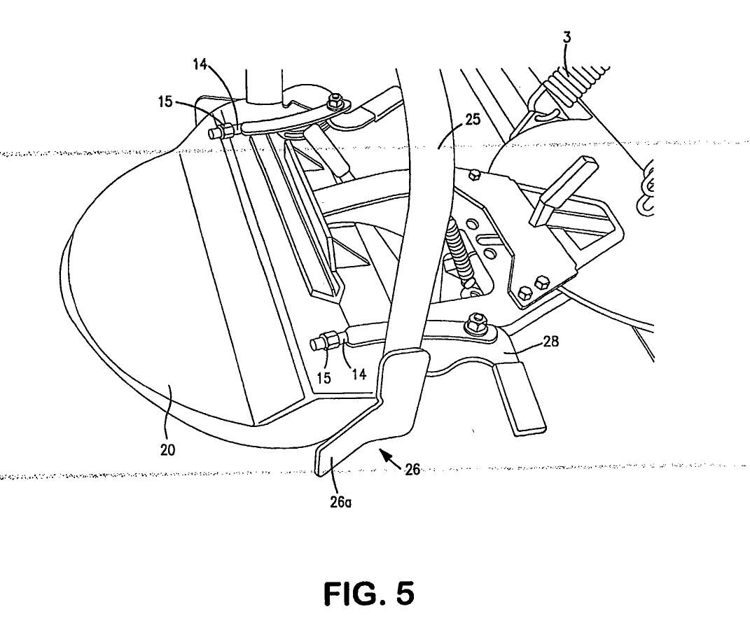

Further details will now be provided regarding the hitch mount of the present invention, with reference to FIG. 3. A semi-circular or arc-shaped male extension 20 extends from lift frame 25 and is adapted to be received by the receiver 11. Due to the shape of the extension 20, if the extension 20 is not perfectly aligned (horizontally) with the receiver cavity, it will self-align as it is brought into further position within the cavity due to physical contact with the sides 7a and/or 7b. Although not required, stops 26 can be coupled to the lift frame 25 to assist in alignment. As seen in FIG. 5, preferably the stops 26 include a tapered portion 26a that extends outwardly away from the extension 20 in the plane of the extension 20. The stops 26 function to urge the assembly towards the center of the receiver cavity during the alignment procedure.

Attached at the end of the mounting implement assembly opposite the extension 20 is the working implement, such as a snow plow blade (although those skilled in the art will appreciate that the present invention is not limited to mounting and dismounting of a blade). The blade can be conventional in design. The preferred blade is made of sheet metal, or is a sheet of steel bumped or rolled to a semi-round shape. The blade also can be in the form of an adjustable V-shaped blade. The blade is braced on the backside with a plurality of mounts providing a means of attachment (such as via springs 3) to the support frame and preferably an A-frame 30. The A-frame can be pivotally coupled directly to the blade or working implement, or can be attached to the blade or working implement through an optional trip flame assembly. Those skilled in the art will appreciate that although the term “A-frame” is used herein, the frame need not be in the shape of an “A”. Male extension 20 is pivotally coupled to the A-frame by suitable means, allowing the extension 20 to pivot about a horizontal axis. Those skilled in the art will appreciate that the free end of the extension 20 can be formed as two or more extensions rather than a single continuous end as shown. The hitch member 20 pivots about a horizontal axis, preferably about 20° from horizontal in each direction.

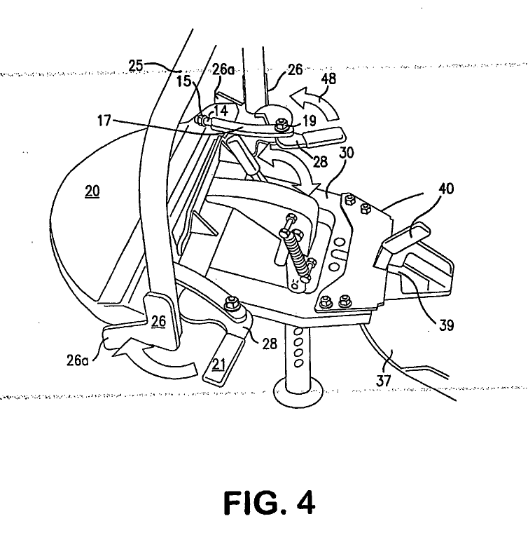

Turning now to FIG. 4, an optional trip frame assembly is shown that includes half-ring or A-frame retainer supported on the top surface of the A-frame 30. Those skilled in the art will appreciate that the half-ring can be designed having shapes other than that shown. The trip frame assembly preferably is connected to the blade via springs 3 (not shown). The trip frame assembly allows the blade to pivot forward, which allows it to trip over obstacles and absorb shock that would otherwise be transferred into the plow frame assembly and vehicle, which in extreme cases would cause substantial damage. If the trip frame assembly is eliminated, the blade can have a conventional trip edge as known in the art.

Extending from the half-ring or retainer 36 is a notched plate 37, also supported on the A-frame top surface, to set the blade angle. The plate 37 has a plurality of spaced notches 39 extending around the annular edge of the plate 37. As the blade pivots, the notched plate 37 also pivots, and can be locked in place with locking mechanism 40 that, when properly aligned with a notch, inserts into that notch to prevent movement of the plate (and thus the blade) until it is retracted from the notch. Those skilled in the art will appreciate that the locking mechanism can be operated manually.

Receiver 11 includes generally longitudinally extending (in the direction from the vehicle front to the vehicle rear) side guide members 7a, 7b as discussed above, which help ensure proper alignment of the hitch assembly. The spacing or volume or distance between these guide members is configured to accommodate the male hitch extension 20 pivotally coupled to the frame. Thus, in the embodiment shown, the hitch member 20 is semi-circular and expands in the direction towards the implement (and away from the vehicle). Similarly, sides 7a, 7b are configured and placed such that the receiver volume is tapered, with its end farthest from the entry point of the mount being shorter than the end closest to the entry point. The sides 7a, 7b thus act as a track for receiving and aligning hitch 20. Those skilled in the art will appreciate that two or more receivers 11 can be used, in which case two or more hitch members would be used.

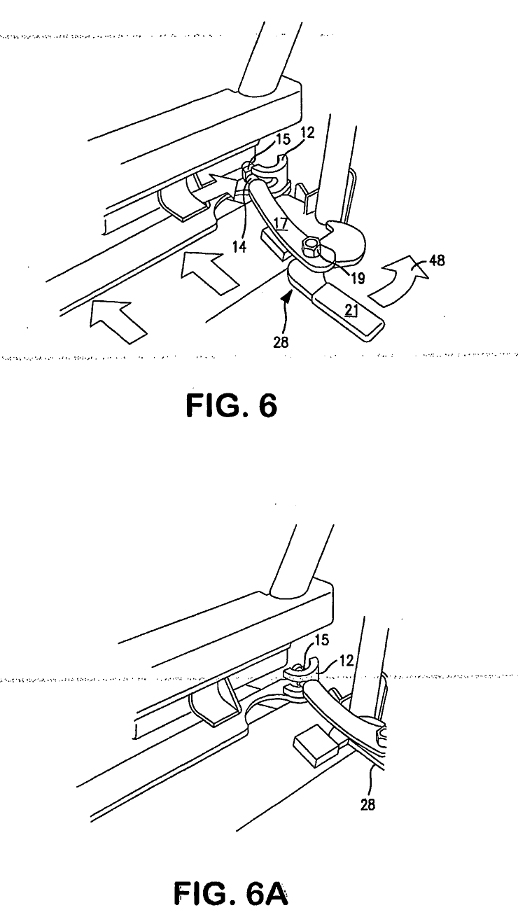

Pivotally coupled to mount assembly are a pair of spaced over-center latches 28, which in the embodiment shown, are located at the lateral side edges of the assembly. Preferably the latches are actuated independently. Each latch 28 has a handle 21 for actuation of the latch. The handle 21 is pivotally connected to member 17 by suitable means such as a pin or a nut and bolt assembly 19. Actuation of the handle 21 in the direction of arrow 48 in FIG. 6 laterally away from the A-frame causes the member 17 to pivot about a vertical axis defined by the assembly 19, thus causing member 15 to slide in the slot 13 and pull the receiver 11 and the mounting assembly together, securing the assembly to the vehicle. This actuation preferably causes member 15 to seat within the concave cavity of the slotted member 12. Preferably the latch has a range of from about 2 to about 4 inches; the member 15 extending laterally a maximum of about 4 inches when in the disengaged position and two inches when engaged. Because an over-center latch is used, most of the force to draw the receiver and hitch mounting assembly together is required up through the latch reaching its center position. Accordingly, once the latch has passed its center position (as in the left-hand latch 28 of FIG. 3), the latch is effectively in a locked state. Similarly, to unlock the latch 28, force is thus required to cause the latch to again pass through its center position and release the member 15 from behind the slot 13. skilled in the art will appreciate that more than one pin (and thus more than one aperture) can be provided to lock the assembly in place.

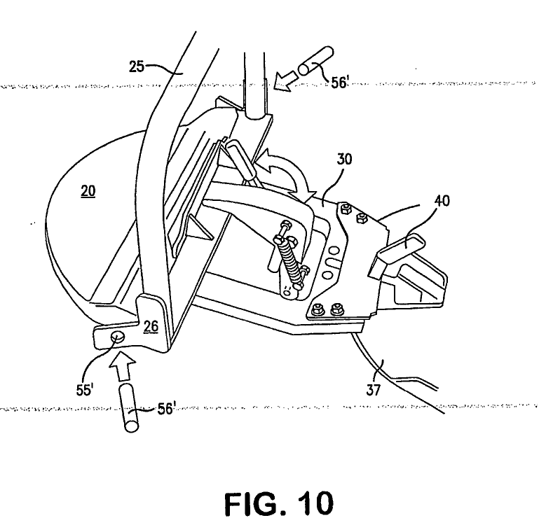

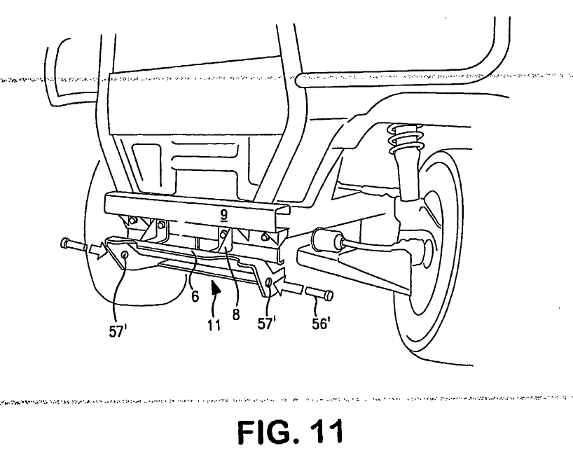

FIGS. 10 and 11 illustrate a still further embodiment of a pin attachment system. In this embodiment, the each of the guides 26 is provided with an aperture 55′. (only one shown). Corresponding apertures 57′ are provided on the sides 7a, 7b of the receiver 11 (FIG. 11). When the male extension 20 is properly engaged in the receiver 11, each aperture 55′ aligns with a respective aperture 57′ of the receiver. Pins 56′ can then be inserted to lock the assembly in place. The pins 56′ can be chamfered to assist in insertion into the apertures upon alignment. The pins also can be spring-loaded to automatically insert into the apertures upon alignment.

The preferred method for attaching the hitch mounting assembly to the vehicle will now be described. The vehicle is positioned close to the hitch mounting assembly, and the vehicle is driven toward the assembly. The free end of the hitch extension member 20 enters the cavity of the receiver 11 and self-aligns therein in view of the corresponding shapes of the receiver 11 and hitch member 20. Once the member 20 is fully within the cavity of the receiver, the latches 28 can be actuated to draw the receiver and mounting assembly together and complete the attachment. Where the working implement coupled to the assembly is a blade., the blade can be raised and lowered in a conventional manner, such as via chain 41 (FIG. 3) extending from the frame of the mount assembly to the lift assembly 25 as shown.

To remove the hitch mounting assembly from the vehicle chassis, the latches 28 are released and the vehicle is driven away from the mounting assembly.

Those skilled in the art will appreciate that although the foregoing illustrates a front-mounted assembly, mounting the same to the rear of the vehicle is within the scope of the present invention.

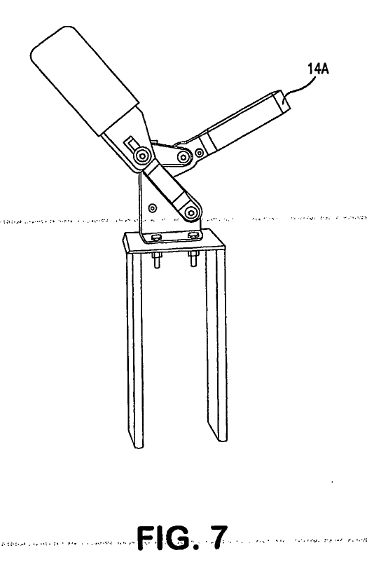

It is within the scope of the present invention to use other over-center latch devices, such as that shown in FIG. 7. In the embodiment of FIG. 7, the extension 14A is oval-shaped, and is therefore adapted to engage and draw a pin or other member extending vertically on the receiver 11. Those skilled in the art will appreciate that regardless of the type of over-center latch used, the parts can be reversed such that the latch can be positioned on the received and the pin or other mechanism that is engaged by the latch can be positioned on the mounting assembly.

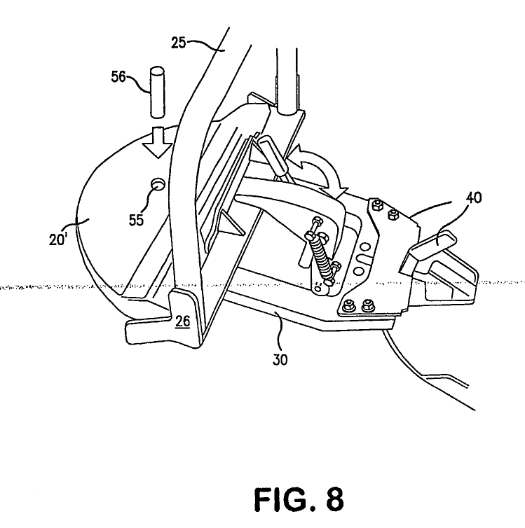

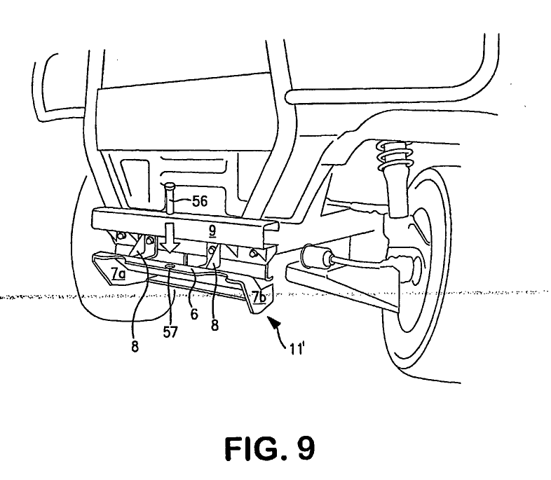

Turning now to FIGS. 8 and 9, a further embodiment of the present invention is illustrated that uses a pin connection instead of over-center latches. Thus, male extension 20′ includes aperture 55, preferably centrally located relative to the the lateral edges of the lift frame 25. A pin 56 is dimensioned to slidingly fit in aperture 55. The pin 56 can be chamfererd to assist in aligning it in the appropriate apetures. Receiver 11′ includes in its top plate 6 a corresponding aperture 57. The aperture 57 is suitably positioned on top plate 6 so that when the male extension 20′ is properly aligned in the receiver cavity, aperture 57 is vertically aligned with aperture 55 in the male extension 20′. Pin 56 is then inserted into the apertures to lock the male extension 20′ in place. Preferably the pin 56 is inserted from the top, through an aligned aperture in the frame 9 as shown in FIG. 9. The pin can be spring-loaded so that it automatically inserts into the aperture upon alignment. Those

What is claimed is:

1. A hitch mounting assembly for a vehicle having a receiver, comprising:
a frame supporting a working implement;
a hitch member pivotable about a pivot axis, said hitch member having an arc-shaped free end adapted to be received by said receiver; whereby said hitch member is shaped to align in and be received by said receiver; and
a locking mechanism for securing said hitch member in said receiver.

2. The hitch mounting assembly of claim 1, wherein said locking mechanism comprises at least one over-center latch for engaging said receiver.

3. The hitch mounting assembly of claim 2, further comprising a second over-center latch spaced laterally from the other.

4. The hitch mounting assembly of claim 1, wherein said receiver and said hitch member each comprise an aperture, and wherein said locking mechanism comprises a pin shaped to be received in each of said apertures when said apertures are aligned.

5. The hitch mounting assembly of claim 1, wherein said working implement is a snow plow blade.

6. The hitch mounting assembly of claim 1, wherein said vehicle is a UTV.

7. The hitch mounting assembly of claim 1, wherein said vehicle has a maximum horsepower capacity of about 35.

8. A method of attaching a hitch mounting assembly to a vehicle having a receiver, said hitch mounting assembly comprising a frame supporting a working implement, a hitch member pivotable about a pivot axis, said hitch member having a free end adapted to be received by said receiver, and at least one over-center latch for engaging said receiver, said method comprising:
driving said vehicle towards said free end of said hitch member of said hitch mounting assembly, causing said hitch member to be slidingly received by said receiver and said at least one latch to engage said receiver.
